(19) United States
(12) Patent Application Publication
(10) Pub. No.: US 2025/0265572 A1
(43) Pub. Date: Aug. 21, 2025

(54) UTILIZING SIGNAL-EMITTING CARDS TO IMPROVE SECURITY, EFFICIENCY, AND ACCURACY OF USER INTERFACE DIGITAL INFORMATION ENTRY AND VALIDATION ACROSS COMPUTER NETWORKS

(71) Applicant: Lyft, Inc., San Francisco, CA (US)

(72) Inventors: Edward L. Gutman, Tiburon, CA (US); Kostiantyn Sergeevich Levytskyi, Vinnytsia (UA); Rodrigo A. Rallo-Del Castillo, San Diego, CA (US); Abhishek Ravi, Chicago, IL (US); John Michael Sparks, San Francisco, CA (US)

(21) Appl. No.: 18/443,990

(22) Filed: Feb. 16, 2024

(51) Int. Cl. G06Q 20/34; G06K 19/07; G06Q 20/40

(52) U.S. Cl. CPC G06Q 20/352; G06K 19/0723; G06Q 20/353; G06Q 20/4016

(57) ABSTRACT

The present disclosure relates to systems, non-transitory computer-readable media, and methods for utilizing signal-emitting cards to improve security, efficiency, and accuracy of user interface digital information entry and validation across computer networks. For example, the disclosed systems can provide for display on a mobile device a plurality of graphical user interface fields. In one or more embodiments, the disclosed systems can extract card information from a signal-emitting card by scanning a wireless signal tag of the signal-emitting card via a mobile device. In one or more embodiments, the disclosed systems can transmit the card information to a database and associate the card information with a wireless signal scanning flag. The disclosed systems can cause the mobile device to populate the plurality of graphical user interface fields with the scanned card information associated with the signal-emitting card.

### BACKGROUND

Recent years have seen a significant increase in hardware and software platforms that utilizes various card-based workflows for transmitting digital information as part of a network-based transaction across computing devices. For example, conventional can initiate a digital transaction between accounts based on stored payment card information. Despite recent advances, conventional systems continue to suffer from a number of technical disadvantages related to security, efficiency, and accuracy of implementing computing devices.

For example, the popularity of digital transactions within web and mobile application has led to an increase in digital fraud and security breaches across computer networks. For example, fraudulent devices illegally collect payment card information, create an account within a web and/or mobile application using the stolen payment card information, and make in-app and/or online purchases with the stolen information. Some existing systems try combating digital fraud by verifying card ownership during transactions (e.g., confirming a billing address, requesting an CVV, or asking for a photo of the payment card); however, fraudulent devices often have access to such digital information or utilizes alternative approaches to bypass these measures. For example, some fraudulent devices generate fake payment cards with stolen card information and validate the card by capturing a photo of the fake payment card.

In addition to technical digital security problems, conventional systems are also computationally inefficient. For example, conventional systems often gather card information by providing an graphical user interface and requiring client devices to enter in the relevant card information (e.g., utilizing individual user interface interactions). Some systems require users to open a camera application, align a camera with card information, and capture a digital image of the card. Such methods require a variety of unnecessary user interactions, interfaces, and processing resources to collect and enter card information via a graphical user interface.

Additionally, existing systems are inaccurate. For example, some conventional systems capture a digital image of a payment card and identify information contained on the card. As a result, many conventional payment storage systems inaccurately identify information from a payment card by either missing digits, letters, or other characters (or predicting such characters incorrectly). As a result, some existing systems provide additional user interfaces that require excessive user interaction to correct inaccurate information.

These along with additional problems and issues exist with regard to conventional systems.

### BRIEF SUMMARY

Embodiments of the present disclosure provide benefits and/or solve one or more of the foregoing or other problems in the art with systems, non-transitory computer-readable media, and methods for utilizing signal-emitting cards to improve security, efficiency, and accuracy of user interface digital information entry and validation across computer networks. In some embodiments, the disclosed systems can provide for display a graphical user interface with input fields on a mobile device. In one or more embodiments, the disclosed systems extract card information associated with a signal-emitting card by scanning a wireless signal tag of the signal-emitting card with the mobile device (without initiating a card transaction). In one or more embodiments, the disclosed systems can transmit the card information to a database and associate the card information with a wireless signal scanning flag. Subsequently, the disclosed systems can cause the mobile device to populate the input fields within the graphical user interface with the card information associated with the signal-emitting card. Moreover, in some implementations, the disclosed systems freeze (e.g., prohibit modification) of the input fields upon scanning the signal-emitting card to preserve the fidelity of the scanned card information from further manipulation. As discussed in more detail below, the disclosed system can also reduce digital fraud and improve security by verifying card information and ownership utilizing the wireless signal scanning flag and stored card information in relation to subsequent network-based transactions utilizing the mobile device. In this manner, the disclosed systems can reduce interactions needed to enter card information via mobile devices, improve accuracy of card information collected via mobile devices, and improve security of network-based transactions initiated at mobile devices.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below. The drawings are not necessarily drawn to scale.

FIG. 1 illustrates a diagram of an environment in which a signal tag system can operate in accordance with one or more embodiments.

FIG. 2 illustrates an overview of the signal tag system causing a mobile device to populate a plurality of graphical user interface fields with card information associated with a signal-emitting card and verifying ownership of the signal-emitting card in accordance with one or more embodiments.

FIG. 3 illustrates the signal tag system extracting card information from the signal-emitting card in accordance with one or more embodiments.

FIG. 4 illustrates the signal tag system validating the card information associated with the signal-emitting card in accordance with one or more embodiments.

FIG. 5 illustrates the signal tag system generating a response to a subsequent request to utilize the signal-emitting card in accordance with one or more embodiments.

FIG. 6 illustrates a flowchart of a series of acts in a method of causing a mobile device to populate a plurality of graphical user interface fields with card information associated with a signal-emitting card in accordance with one or more embodiments.

FIG. 7 illustrates a block diagram of an example computing device for implementing one or more embodiments of the present disclosure.

FIG. 8 illustrates an example environment for a transportation matching system in accordance with one or more embodiments.

### DETAILED DESCRIPTION

This disclosure describes one or more embodiments of a signal tag system that utilizes signal emitting cards to improve security, efficiency, and accuracy of user interface digital information entry and validation across computer networks. In particular, the signal tag system can efficiently populate fields of a graphical user interface with card information from a signal-emitting card without initiating a card transaction. For example, the signal tag system provides for display one or more input fields via a graphical interface of a mobile device. In one or more implementations, the signal tag system extracts card information from a signal-emitting card through the mobile device. In particular, in one or more embodiments, the signal tag system directs a mobile device to scan a wireless signal tag of the signal-emitting card and determines the card information associated with the signal-emitting card (without initiating a card transaction). In certain implementations, the signal tag system can transmit the card information to a database and associate the card information with a wireless signal scanning flag. Subsequently, in one or more embodiments, the signal tag system populates the input fields of the graphical user interface with the scanned card information associated with the signal-emitting card.

As indicated above, the signal tag system can provide a plurality of graphical user interface fields via a graphical user interface of a mobile device. For instance, the signal tag system can provide one or more graphical user interface fields that correspond to card information associated with the signal-emitting card. For example, in one or more embodiments, the plurality of graphical user interface fields can include fields for a payment card number, expiration data, zip code, name, and/or card verification value.

Additionally, the signal tag system can determine card information for a signal-emitting card by extracting card information associated with the signal-emitting card via the mobile device. For example, the signal tag system can prompt the mobile device to scan a wireless signal tag of the signal-emitting card. In one or more embodiments, scanning the wireless signal tag triggers one or more action events that can extract an account number and an expiration date associated with the signal-emitting card. In some cases, the signal tag system can extract the card information without processing a transaction for the signal-emitting card.

In addition to extracting card information associated with the signal-emitting card, the signal tag system can transmit the card information to a database. In some embodiments, the signal tag system associates the card information in the database with a wireless signal scanning flag. In one or more cases, the wireless signal scanning flag can indicate that the signal tag system extracted the payment information by scanning the wireless signal tag of the signal-emitting card (e.g., by tapping the card). In one or more embodiments, based on the association with the wireless signal scanning flag, signal tag system can verify the authenticity of the signal-emitting card by requesting an additional scan of the signal-emitting card.

For example, after adding the signal-emitting card to a user account by scanning the wireless signal tag of the signal-emitting card, the signal tag system can receive a subsequent request to initiate a transaction with the signal-emitting card. In one or more embodiments, the signal tag system can generate a response to the request by verifying that an authorized user associated with the user account of the client application has physical custody of the signal-emitting card. For example, the signal tag system can request an additional scan of the signal-emitting card, and based on receiving the additional scan, approve the request to initiate the transaction.

In one or more embodiments, the signal tag system can cause the mobile device to populate the plurality of graphical user interface fields of the graphical user interface of the mobile device with the scanned card information. In particular, the signal tag system can provide for display via the graphical user interface of the mobile device the account number and the expiration date of the signal-emitting card. In some cases, based on associating the card information with the wireless signal scanning flag, the signal tag system can freeze and/or obfuscate payment information of the signal-emitting card. By freezing various input fields, the signal tag system can preserve the fidelity of the scanned information from the card associated with the wireless signal scanning flag.

The signal tag system provides a variety of technical advantages and benefits over conventional systems. For example, the signal tag system can provide improved security. In particular, the signal tag system can verify that an authorized user is performing actions and/or making transactions with the signal-emitting card within a client application. For example, based on adding the payment information for the signal-emitting card by scanning the wireless signal tag, the signal tag system determines that the authorized user associated with the user account had physical control of the signal-emitting card. In instances of potential fraudulent activity involving the signal-emitting card, the signal tag system can confirm that a fraudulent party did not steal card information by confirming that the authorized user has possession of the signal-emitting card by requesting an additional scan of the signal-emitting card and confirming the payment information associated with the signal-emitting card.

Additionally, the signal tag system improves GUI efficiency. In particular, the signal tag system reduces the number of interactions with the graphical user interface of the mobile device. For example, unlike existing systems that require 28 inputs/interactions (or more) with the graphical user interface while entering payment information, the signal tag system populates graphical user interface fields with the account number and expiration date of the signal-emitting card. Thus, the signal tag system can significantly reduce time, user interfaces, and computing resources relative to conventional systems.

Moreover, the signal tag system improves accuracy. As previously mentioned, the signal tag system can extract payment information from a wireless signal tag without initiating a network transaction. Unlike some existing systems, the signal tag system does not identify payment information by relying on inaccurate images of the signal-emitting card or ineffective predictive algorithms. By extracting payment information directly from the wireless signal tag, the signal tag system ensures the accuracy of the payment information of the signal-emitting card.

As indicated by the foregoing discussion, the present disclosure utilizes a variety of terms to describe features and advantages of the signal tag system. For example, as used herein, the term “mobile device” refers to a portable computing device, such as a smartphone, wearable computing device (e.g., glasses or watch), tablet or other computing device. A mobile device includes a computing device that performs transactions, runs various applications, and has the capacity to recognize, scan, and/or communicate with a wireless signal tag of a signal-emitting card. A mobile device can include a mobile phone or a tablet that can transmit a request, initiate a transaction, or scan a wireless signal tag utilizing a mobile application or a web-based application. In one or more embodiments the mobile device can include a near field communication system or chip.

As used herein, the term “signal-emitting card” refers to physical card that includes a wireless signal tag. In some cases, the signal-emitting card can correspond to sensitive, personal, or private information, such as a name or card information. For example, a signal-emitting card can include, but is not limited to, a payment card (e.g., credit card, debit card, atm card, etc.), driver's license, or a government identification card. In some embodiments, a signal-emitting card can include an integrated near field communication chip and/or antenna.

Relatedly, as used herein, the term “card information” relates to personal, financial, or sensitive information associated with a signal-emitting card. For instance, in one or more cases, card information can correspond to a financial institution (bank, credit union) and enable transactions. To illustrate, card information can include an account number, expiration date, zip code, billing address, CVV, card issuer, card type, card state, card holder's first name, card holder's last name, bank identifier code, international bank account number, list of transactions, and/or security certificates. In one or more embodiments, card information can relate to personal identifying information such as, but not limited to, a driver's license number, passport number, social security number, home address, work identification number, school identification number, date of birth, or issuance date.

As used herein, the term “wireless signal tag” refers to a object item, or indicator that enables short range wireless communication between a signal-emitting card and mobile device. For example, a wireless signal tag can be a near field communication (NFC) tag and/or integrated circuit chip embedded in the signal-emitting card. In some embodiments, the wireless signal tag can store payment and/or card information and enable data transfers between the signal-emitting card and the mobile device. For example, in one or more implementations, the mobile device can come into close proximity of the wireless signal tag of the signal-emitting card by scanning and/or tapping the wireless signal tag, and the signal tag system can extract card information like the account number and/or expiration date of the signal-emitting card.

As used herein, the term “wireless signal scanning flag” refers to an indication specifying that card information associated with signal-emitting card was extracted by scanning the wireless signal tag. For example, the wireless signal scanning flag can be a combination of number and/or letters assigned to the card information. In one or more embodiments, the signal tag system can store the wireless signal scanning flag and the card information associated with the signal-emitting card in a database. In some cases, the signal tag system can utilize the wireless signal scanning flag to validate the card after adding the card information to a client application. For example, in cases where the signal-emitting card might be involved in fraudulent transactions, the signal tag system can validate the authenticity of the signal-emitting card by utilizing offline data authentication (ODA) and/or requesting an additional scan of the signal-emitting card.

As used herein, the term “card risk model” refers to a computer-implemented algorithm, architecture, or framework that measures the risk of fraudulent activity associated with a (signal-emitting) card. For example, in one or more embodiments, the card risk model can be a machine learning model, algorithm, or other artificial intelligence algorithm that can identify patterns indicating fraudulent behavior. For example, the card risk model can analyze features associated with the signal-emitting card, user account associated with the signal-emitting card, mobile device within a client application and/or transaction. In one or more embodiments, the signal tag system can determine a threat prediction by inputting the features and the wireless signal scanning flag into a machine-learning model or other artificial intelligence framework.

Relatedly, as used herein the term “threat prediction” refers to a likelihood, probability, or indication that one or more actions or requests associated with the signal-emitting card are fraudulent (e.g., a fraud or risk prediction). For example, the threat prediction can indicate that an unauthorized user is trying to initiate a transaction with the signal-emitting card without physical control of the signal-emitting card. In some instances, based on the threat prediction, the signal tag system can generate a response to a request. For example, if the signal tag system receives a request to pay for transportation services with card information associated with the signal-emitting card and the threat prediction indicates a high likelihood that the request is fraudulent, the signal tag system can generate a response denying the transaction or requesting an additional scan of the signal-emitting card.

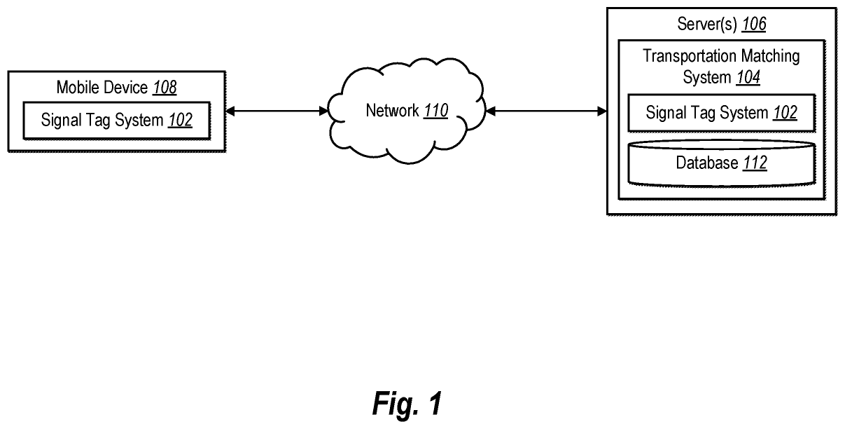

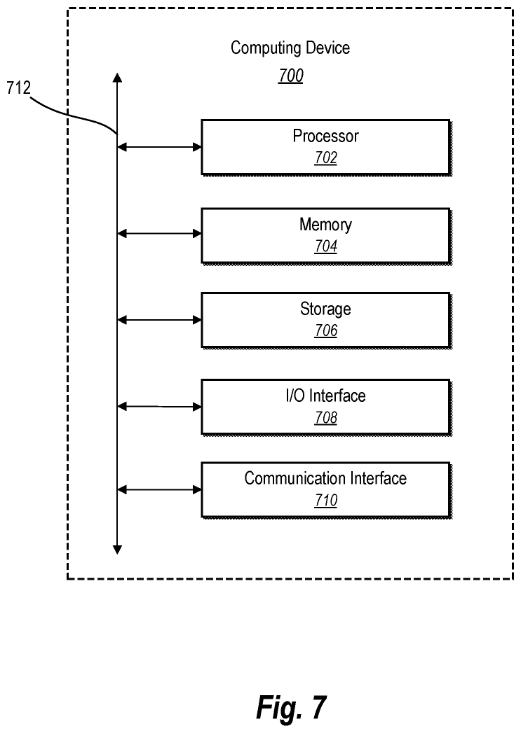

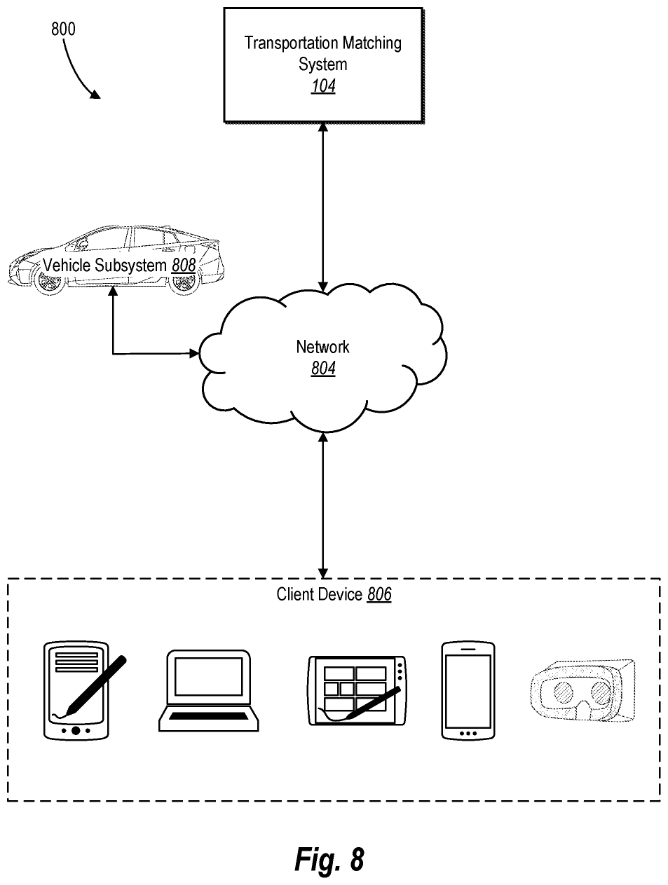

Additional detail regarding the signal tag system will now be provided with reference to the figures. In particular, FIG. 1 illustrates a block diagram of a system environment for implementing a signal tag system 102 in accordance with one or more embodiments. As shown in FIG. 1, the environment includes the server(s) 106 housing the signal tag system 102 as part of a transportation matching system 104. The environment of FIG. 1 further includes a mobile device 108 and a network 110. The server(s) 106 can include one or more computing devices to implement the signal tag system 102. The mobile device 108 may be or comprise one or more of a variety of computing devices as described in FIGS. 7-8. Additional description regarding the illustrated computing devices (e.g., the server(s) 106, the mobile device 108) is provided with respect to FIGS. 7-8 below.

As shown, the signal tag system 102 utilizes the network 110 to communicate with the mobile device 108. For example, the signal tag system 102 communicates with the mobile device 108 to facilitate transactions, requests, and storage of card information and/or wireless signal scanning flags within the transportation matching system 104. Indeed, the signal tag system 102 can extract card information from signal-emitting cards and transmit the card information to a database 112. In some embodiments, per device settings, the signal tag system 102 receives device information from the mobile device 108 such as location coordinates of the mobile device 108, transaction history, and/or payment methods.

As indicated above, the signal tag system 102 can cause the graphical user interface of the mobile device 108 to display a plurality of graphical user interface fields that correspond to card information. For example, the graphical user interface fields can correspond to an account number, expiration date, zip code, CCV, card issuer, first name of the card holder, last name of the card holder, etc. associated with the signal-emitting card. In some embodiments, based on the type of signal-emitting card, the signal tag system 102 can provide for display different graphical user interface fields.

Although FIG. 1 illustrates the environment having a particular number and arrangement of components associated with the signal tag system 102, in some embodiments, the environment may include more or fewer components with varying configurations. For example, in some embodiments, the transportation matching system 104 can communicate directly with the mobile device 108 bypassing the network 110. Moreover, the environment can include a variety of mobile devices. In these or other embodiments, the signal tag system 102 can be housed on and/or implemented by (entirely or in part) the mobile device 108. Additionally, the signal tag system can include or communicate with a database for storing card information, mobile device information, wireless signal scanning flags and/or other information described herein.

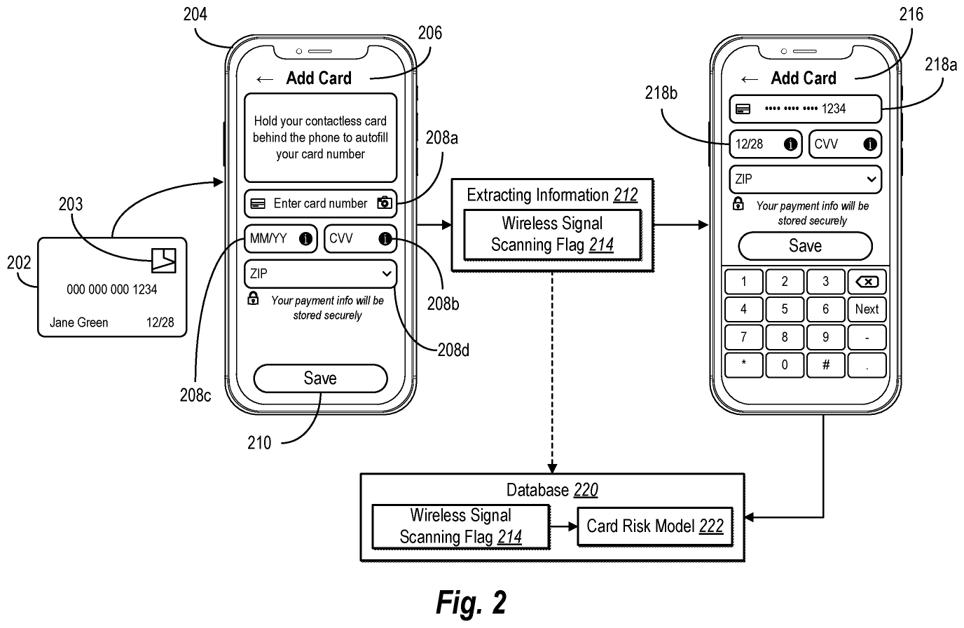

As mentioned, the signal tag system 102 can cause a mobile device to populate a plurality of graphical user interface filed with scanned card information associated with a signal-emitting card. FIG. 2 illustrates an overview of signal tag system causing a mobile device to populate a plurality of graphical user interface fields with card information associated with a signal-emitting card and verifying ownership of the signal emitting card in accordance with one or more embodiments.

Specifically, FIG. 2 shows the signal tag system 102 extracting information 212 from the signal-emitting card 202, generating a wireless signal scanning flag 214, and populating a plurality of graphical user interface fields 208a-d. For instance, FIG. 2 shows the signal tag system 102 providing for display via a graphical user interface 206 with a plurality of graphical user interface fields 208a-d on a mobile device 204. In some cases, the graphical user interface fields 208a-d can represent different elements of card information associated with the signal-emitting card 202. For example, a graphical user interface field 208a can correspond to the account number for the signal-emitting card 202. Relatedly, in some cases, graphical user interface field 208b can correspond to the card verification value (CVV) of the signal-emitting card 202. In some embodiments, graphical user interface field 208c can correspond to the expiration date of the signal-emitting card 202. Moreover, in some cases graphical user interface field 208d can correspond to the zip code of the billing address associated with the signal-emitting card 202. In one or more embodiments, the graphical user interface can include a selectable save element 210 for saving the card information associated with the signal-emitting card 202.

In some embodiments, based on the type of signal-emitting card 202, the signal tag system 102 can provide for display graphical user interface fields that reflect information associated with the signal-emitting card 202. For instance, in one or more embodiments, where the signal-emitting card 202 corresponds to sensitive or personal identifying information, the signal tag system 102 can provide for display a plurality of graphical user interface fields for the sensitive or personal identifying information. For example, in an embodiment where the signal-emitting card 202 is a driver's license, the signal tag system 102 can provide for display a plurality of graphical user interface fields that corresponds to the driver's license number, issuing state, and/or issue date of the driver's license.

As further shown in FIG. 2, the signal tag system 102 can perform the act of extracting information 212 by scanning or tapping the signal-emitting card 202 with the mobile device 204. For example, as described above the signal-emitting card 202 can include a wireless signal tag 203 that contains card information associated with the signal-emitting card 202. In some cases, the wireless signal tag 203 can transfer data, or more specifically, card information, by coming within a certain distance of the mobile device 204. For example, in one or more embodiments, the signal tag system 102 can extract information from the wireless signal tag 203 by positioning the mobile device 204 within a distance of 5 centimeters or less.

As mentioned above, in one or more embodiments, the signal tag system 102 can extract information via the mobile device 204 scanning the wireless signal tag 203. In one or more embodiments, the wireless signal tag 203 can be an NFC chip or internal circuit and the mobile device 204 can include an NFC chip reader. As indicated above, in one or more implementations when the NFC chip of the signal-emitting card 202 comes within five centimeters of the NFC chip reader of the mobile device 204, the signal tag system 102 can extract the card information associated with the signal-emitting card 202 from the wireless signal tag 203.

As further shown in FIG. 2, the signal tag system 102 can associate a wireless signal scanning flag 214 with the extracted information 212 (e.g., card information). In particular, the signal tag system 102 can transmit, without initiating a transaction, the card information from the signal-emitting card 202 to a database 220 and assign or associate the card information with the wireless signal scanning flag 214. As discussed in more detail below, the signal tag system 102 can utilize the wireless signal scanning flag 214 to verify and/or validate the card information associated with the signal-emitting card 202. For example, upon receiving a request to initiate a transaction with card information associated with the signal-emitting card 202, the signal tag system 102 can request an additional scan of the signal-emitting card 202. More specifically, in one or more embodiments, when the signal tag system 102 determines that a request to utilize the signal-emitting card 202 has higher likelihood of fraudulent activity, the signal tag system 102 can verify possession of the signal-emitting card 202 by requesting an additional scan of the signal-emitting card 202. In one or more embodiments, during the additional scan, the signal tag system 102 can utilize public keys and certificates to validate the card information. Relatedly, and as further shown in FIG. 2, in one or more embodiments, the signal tag system 102 can utilize the wireless signal scanning flag 214 and a card risk model 222 to generate a threat prediction for a request to utilize the signal-emitting card 202.

FIG. 2 further shows, an embodiment where the signal tag system 102 causes the mobile device 204 to populate the plurality of graphical user interface fields 208a-b with the card information in a second graphical user interface 216. For example, as shown in FIG. 2, the signal tag system 102 can provide for display the populated the graphical user interface fields 218a-b with the account number and expiration date for the signal-emitting card 202. Moreover, in one or more implementations, the signal tag system 102 can freeze and/or obfuscate one or more of the plurality of graphical user interface fields in response to causing the mobile device 204 to populate the plurality of graphical user interface fields with the scanned card information.

The signal tag system 102 can freeze graphical user interface fields to prohibit interaction with the user interface field and modification of the card information. Indeed, as discussed in greater detail below, the signal tag system 102 can utilize the wireless signal scanning flag 214 (in subsequent transactions) to indicate that the mobile device 204 had possession of the card 202 and therefore reduce the likelihood of fraud predictions in utilizing risk prediction models for subsequent transactions. However, if the signal tag system 102 generates the wireless signal scanning flag 214 and the mobile device 204 changes the card information of the user interface fields 218a-b, the card modified card information may actually include fraudulent details disassociated from the signal-emitting card 202. Accordingly, in some implementations, the signal tag system 102 freezes the user interface fields 218a-b (and/or other user input fields) upon scanning of the signal-emitting card 203 (and/or creation of the wireless signal scanning flag 214). In this manner, the signal tag system 102 can ensure that the stored card information (in the database 220) aligns with the wireless signal scanning flag 214.

The signal tag system 102 can freeze the graphical user interface fields in a variety of ways. For example, the signal tag system 102 can grey out the user interface fields to indicate that the graphical user interface fields cannot be modified. Similarly, the signal tag system 102 can hide information (e.g., card information, expiration date, CVV) so that it is not visible to indicate that the graphical user interface field cannot be modified. In some implementations, the signal tag system 102 does not provide a visual indicator that the graphical user interface fields are frozen but prohibits modification of the card information in the graphical user interface fields. In some embodiments, the signal tag system 102 provides a warning notification or pop-up element in response to user selection of the user interface fields indicating that the user interface fields cannot be modified (e.g., without deleting the scanned card information).

In one or more implementations, if one or more graphical user interface fields are modified, the signal tag system 102 deletes the wireless signal scanning flag 214 from the database 220. In this manner, the signal tag system 102 does not provide any additional risk validation to the card information (if modified) because the card information entered into the user interface may not align with the actual card information scanned from the signal-emitting card 202.

The signal tag system 102 can freeze a variety of different graphical user interface fields. For instance, in some implementations, the signal tag system 102 freezes the fields that contain card information extracted from the signal-emitting card 202. Thus, for example, the signal tag system 102 freezes fields for card number, expiration date, and CVV. The signal tag system 102 can freeze some but not all fields containing card information extracted from the signal-emitting card 202. For example, in some implementations, the signal tag system 102 freezes only the card number (without freezing the expiration date, CVV, or Zip Code).

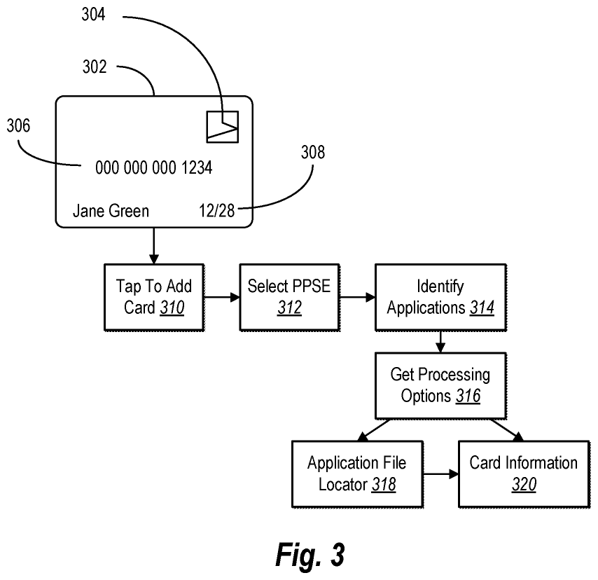

As previously mentioned, the signal tag system 102 can extract card information from a signal-emitting card. FIG. 3 illustrates the signal tag system 102 extracting card information from the signal-emitting card 302 in accordance with one or more embodiments. As shown in FIG. 3, the signal-emitting card 302 can include a wireless signal tag 304, an account number 306 and expiration date 308. In some implementations, the wireless signal tag 304 can store card information displayed and/or linked to the signal-emitting card 302. For example, in one or more embodiments, card information can include an account number 306 and expiration date 308 and the wireless signal tag 304 can store the account number 306 and the expiration date 308. In certain implementations, the wireless signal tag 304 can store card information that goes beyond the account number 306 and expiration date 308. For example, card information can include the card type (e.g., Visa, Mastercard, American Express, etc.) or the bank identifier code (e.g., a standard code that uniquely identifies financial institutions such as a bank or credit union). In some embodiments, the card information can include a list of transactions or activities indicating the amount, cryptogram data, terminal country, currency, date, transaction type, and time of the transaction and/or activity. Additionally, card information can include the state of the card, or in other words, if the card is active, locked, or unknown.

As shown in FIG. 3, the signal tag system 102 can extract the card information via a mobile device scanning the wireless signal tag 304 by performing a set of actions. More specifically, in one or more embodiments, the signal tag system 102 can retrieve information stored in the wireless signal tag 304 by sending commands to the wireless signal tag 304. For example, as shown in FIG. 3, the signal tag system 102 can request a tap to add card action 310. In one or more embodiments, the signal tag system 102 can provide for display a banner on the graphical user interface of the mobile device instructing the user to position the signal-emitting card 302 directly behind the mobile device.

In one or more embodiments, in response to receiving a successful tap to add card action 310 (e.g., detecting the signal-emitting card 302 behind the mobile device), the signal tag system 102 can perform an action that selects a proximity payment system environment (PPSE) 312. In one or more implementations, the PPSE command allows the signal tag system 102 to identify which applications (e.g., Visa, Mastercard, American Express, Discover, etc.) support, regulate, and/or process transactions related to the signal-emitting card 302. For example, as shown in FIG. 3, by sending out the select PPSE action 312, the signal tag system 102 can identify applications 314 (e.g., Visa, Mastercard, American Express, Discovery, etc.) that process transactions related to the signal-emitting card 302. In some embodiments, the select PPSE action 312 only returns a single application. In one or more implementations, the select PPSE action 312 returns a list of applications. In such embodiments, the signal tag system 102 can prioritize the applications.

In one or more embodiments, from the list of applications, the signal tag system 102 can select an application that processes transactions associated with the signal-emitting card 302. Thus, in certain implementations, by selecting an application, the signal tag system 102 can inform the wireless signal tag 304 which application the signal tag system 102 wants to retrieve information from.

As further shown, in one or more implementations, once the signal tag system 102 selects an application, the signal tag system 102 can send a get processing options (GPO) action to the wireless signal tag 304. In one or more embodiments, the GPO action 316 allows the signal tag system 102 to request data and/or parameters necessary for processing transactions. For example, in some cases, the processing parameters of the application can include card information 320 (e.g., the account number 306 and expiration date 308), cardholder verification method list, terminal risk management parameters, etc. Thus, in one or more embodiments, the signal tag system 102 can directly receive the card information 320 associated with the signal-emitting card 302 from the wireless signal tag 304 by sending the GPO action 316.

As further shown in FIG. 3, in some embodiments, the GPO action 316 pulls an application file locator 318 instead of directly pulling the card information 320. In some cases, the application file locator 318 is an identifier for a file that contains card information 320. In some implementations, where the signal tag system 102 receives the application file locator 318, the signal tag system 102 can read and extract card information 320 from the data in the application file locator 318. In some embodiments, once the signal tag system 102 extracts and verifies the card information 320, the signal tag system 102 can tokenize the card information 320.

In one or more embodiments, the signal tag system 102 can perform the aforementioned actions and/or commands via an exchange of an array of bytes structured with specific headers and trailers. In one or more embodiments, the header declares the type of command (e.g., action) and the trailer contains all necessary information that the signal tag system 102 sends to the wireless signal tag 304. In one or more embodiments, the signal tag system 102 receives data from the wireless signal tag 304 in a GPO response.

As discussed above, in one or more embodiments, once the signal tag system 102 extracts the card information 320, the signal tag system 102 can transmit the card information 320 associated with the signal-emitting card 302 to a database. In one or more embodiments, the signal tag system 102 can associate the card information 320 with a wireless signal scanning flag indicating that the signal tag system 102 extracted the card information via a wireless signal tag 304 of the signal-emitting card 302. As indicated above, associating the card information 320 with the wireless signal scanning flag, signifies that the signal tag system 102 extracted card information 320 from the wireless signal tag 304 securely and accurately.

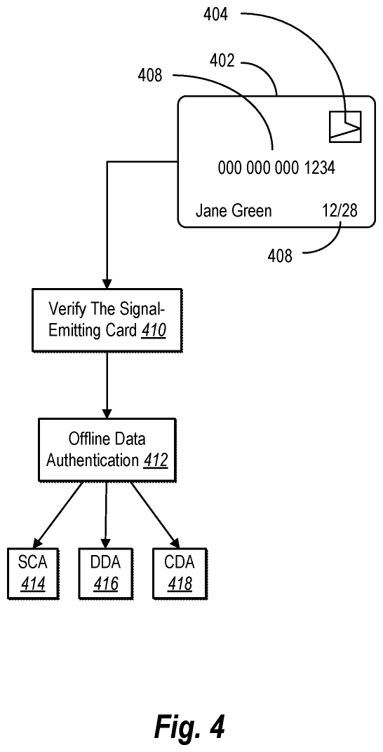

As mentioned above, the signal tag system 102 can improve the security over conventional systems by validating or verifying the signal-emitting card and card information associated with the signal-emitting card. FIG. 4 illustrates the signal tag system 102 validating the signal-emitting card 402 by utilizing public and private keys involved in public-key cryptography.

The signal tag system 102 can utilize public-key cryptography to ensure or verify the authenticity and security of a signal-emitting card 402 (e.g., during a digital transaction or without a transaction) by utilizing pairs of keys (e.g., a public key and a private key) to protect sensitive information (e.g., card information). For example, in one or more implementations, when a card issuer (e.g., financial institution) personalizes the signal-emitting card 402 by adding unique features and/or personal information about the card holder to the signal-emitting card 402, the card issuer signs (e.g., generates a digital signature for) the signal-emitting card 402 with an unknown private key. In one or more implementations, the digital signature of the card issuer provides a means for confirming that the information on the signal-emitting card 402 originated from the card issuer and reflects accurate information about the card holder and signal-emitting card 402. In some cases, the private key corresponds to a public key that can verify the authenticity of the digital signature. In some cases, card issuers (e.g., certificate authority) distribute public keys and/or issuer certificates verifying the authenticity of the card issuer and signal-emitting card 402.

In one or more embodiments, the signal tag system 102 can verify the signal-emitting card 410 by leveraging aspects of public-key cryptology. For example, as shown in FIG. 4, the signal tag system 102 can verify the signal-emitting card 402 by utilizing offline data authentication (ODA) 412. In certain implementations, ODA 412 allows the signal tag system 102 to verify the signal-emitting card 402 and card information 408 without direct online communication with the card issuer. For example, by utilizing ODA 412, the signal tag system 102 can validate the authenticity of the signal-emitting card 402 without processing a transaction or interacting with the card issuer. Consequently, because ODA 412 does not require a response from the card issuer, the signal tag system 102 can quickly and independently validate the signal-emitting card 402 and card information 408 associated with the signal-emitting card 402. Moreover, as indicated above, ODA 412 along with the wireless signal scanning flag allows the signal tag system 102 to detect malicious cards before a user requests a ride or subsequent transactions within the client application by verifying the authenticity of the card information 408 and physical possession of the signal-emitting card 402.

As further shown in FIG. 4, the signal tag system 102 can utilize various ODA 412 methods. For example, in certain implementations the signal tag system 102 can utilize static data authentication (SDA), dynamic data authentication (DDA), or combined data authentication (CDA). As discussed in more detail below, in one or more embodiments, based on the type of ODA 412, the signal tag system 102 can validate card information 408 by utilizing different levels of security.

For example, as shown in FIG. 4, the signal tag system 102 can utilize SDA 414. In one or more embodiments, the signal tag system 102 utilizes SDA 414 to verify the authenticity of the signal-emitting card 402 by ensuring that (i) the card issuer signed the signal-emitting card 402 during personalization and (ii) that the static data associated with the signal-emitting card 402 has not been altered. In certain implementations, the signal tag system 102 can verify the signal-emitting card 402 with SDA by building two levels of security that verify aspects of the signal-emitting card 402.

For example, in one or more embodiments, the signal tag system 102 can utilize the first level of security that verifies the authenticity of the card issuer. For example, in one or more embodiments, the signal tag system 102 can verify the authenticity of the card issuer by verifying the issuer certificate. In certain implementations, the issuer certificate is a digital certificate furnished by the card issuer establishing its authenticity. Moreover, in some implementations, the signal tag system 102 can verify the issuer certificate by determining that the certification authority (e.g., Visa, Mastercard, American Express, etc.) signed issuer certificate with a private key. In one or more embodiments, the signal tag system 102 can determine that the certification authority signed the issuer certificate by accessing the public key that matches the private key. In one or more embodiments the certificate authority publishes public keys in a certification authority public key index and the signal tag system 102 can access and store the certification authority public key index in a database within the transportation matching system 104. In some cases, the signal tag system 102 can fetch the certification authority public key that corresponds to the private key associated with the signal-emitting card 402 and transmit the certification authority public key associated with the signal-emitting card 402 to the wireless signal tag 404 of the signal-emitting card 402. In some embodiments, in response to transmitting the certification authority public key to the wireless signal tag 404, the signal tag system 102 can receive the card issuers public key certificate indicating that the certification authority signed the card issuer certificate.

In some embodiments, the signal tag system 102 can utilize a second level of security that validates that the data on the signal-emitting card 402 is unmodified and approved by the card issuer. In particular embodiments, the signal tag system 102 can verify that the signal-emitting card 402 signed static application data is signed by the card issuer.

As further shown in FIG. 4, the signal tag system 102 can utilize DDA 416. Unlike SDA, DDA 416 prevents fraud by signing dynamic application data with a private key that is unique to the signal-emitting card 402. Thus, in some embodiments, the signal-emitting card 402 with DDA 416 has a first private key associated with the signal-emitting card 402 and a second private key associated with the card issuer. Thus, a signal-emitting card 402 employing DDA 416 assures the integrity and authenticity of the signal-emitting card 402 while preventing replay attacks by utilizing dynamic application data during transactions.

As indicated above, in one or more embodiments, the signal-emitting card 402 can verify the authenticity of the card by implementing various security levels. In one or more embodiments, the signal-emitting card 402 utilizing DDA 416 can implement three levels of security verifying aspects of the signal-emitting card 402. As described above in the SDA 414 implementation, the signal tag system 102 can utilize the first level of security by verifying that the certification authority signed the issuer certificate associated with the signal-emitting card 402.

In one or more embodiments, the signal tag system 102 can utilize a second level of security verifying that the card issuer signed the wireless signal tag 404 of the signal-emitting card 402 with a private key. As described above, in one or more embodiments, the signal tag system 102 can receive the card issuer public key certificate by implementing the first level of security. In certain embodiments, the signal tag system 102 can extract the card issuers public key from the card issuer public key certificate. In some implementations, the signal tag system 102 can transmit the card issuer public key to the wireless signal tag 404 of the signal-emitting card 402 and receive the wireless signal tag 404 public certificate indicating that the card issuer signed the wireless signal tag 404 certificate with the private key.

In one or more cases, the signal tag system 102 can utilize a third security level that validates the integrity of the card information 408 on the signal-emitting card 402 and verifies the dynamic application data utilized by the signal-emitting card 402. In particular, in some embodiments, the signal tag system 102 can verify that the signed dynamic application data is signed with the wireless signal tag 404 private key. As described above in regard to the second security level, the signal tag system 102 can receive the wireless signal tag public key certificate. In one or more embodiments, the signal tag system 102 can extract the wireless signal tag public key from the wireless signal tag public certificate and send an internal authenticate command to the wireless signal tag 404 with a random number to generate signed dynamic application data. In one or more embodiments, the signal tag system 102 verifies the signed dynamic application data by comparing the signed dynamic application data with the wireless signal tag public key.

As further shown in FIG. 4, signal tag system 102 can utilize Combined Dynamic Authentication (CDA) 418 which extends DDA 416 by adding a transaction approval step. For example, the signal tag system 102 can validate the card through DDA 416 and send a generated cryptogram to a card issuer.

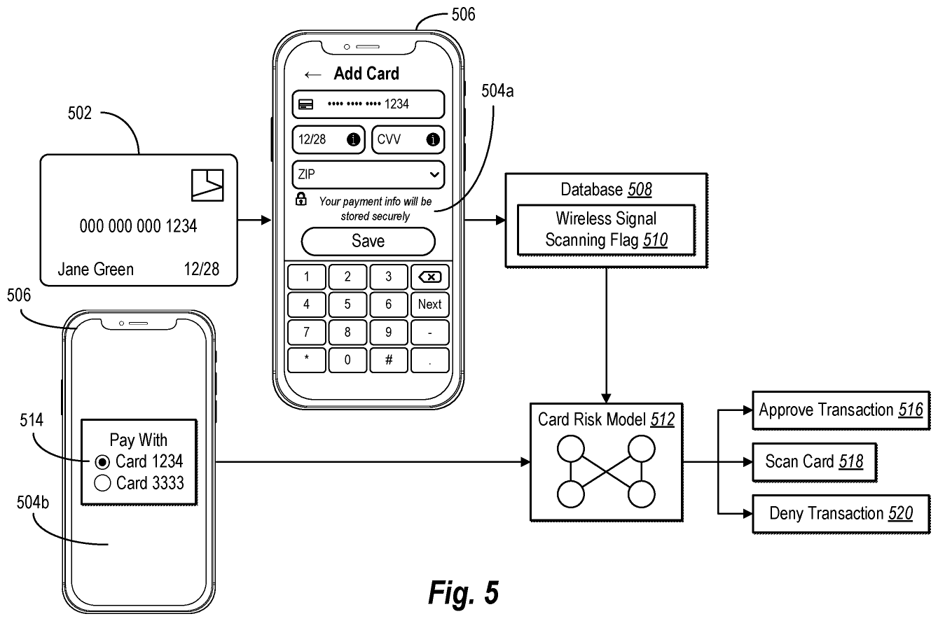

As mentioned above, the signal tag system 102 can improve card security by verifying the physical control of the signal-emitting card 502 by generating one or more responses to a request to utilize the signal-emitting card 502. FIG. 5 illustrates the signal tag system 102 generating a response to a subsequent request to utilize the signal-emitting card in accordance with one or more embodiments.

As shown in FIG. 5 and described above, the signal tag system 102 can scan the signal-emitting card 502 via the mobile device 506, extract card information associated with the signal-emitting card 502, transmit the card information to a database 508 where the signal tag system 102 associates the card information with a wireless signal scanning flag 510, and populate a plurality of graphical user interface fields of the graphical user interface 504a.

As further shown in FIG. 5, the signal tag system 102 can receive a subsequent request to utilize the signal-emitting card 502. As used herein, the term “subsequent request” refers to a request to perform an action with card information associated with a signal-emitting card (e.g., after storing the card information without a transaction). For example, in some cases, a subsequent request can include a request to complete a transaction within the client application with the signal-emitting card. To illustrate, in one or more embodiments, the subsequent request can include a request to pay for transportation services with the signal-emitting card. In one or more embodiments, the subsequent request can include transferring money from a financial account associated with the signal-emitting card into a monetary reserve associated with a user account within the client application. Moreover, in some embodiments, a subsequent request can include payment for delivery service. In some embodiments, the subsequent request can include performing actions with the signal-emitting card, such as but not limited to, linking card the signal-emitting card with an additional user account within the client application, viewing the card information associated with the signal-emitting card, and/or accessing card information associated with the signal-emitting card on an additional mobile device. For example, in one or more embodiments if a second account adds the signal-emitting card, the signal tag system 102 can request and additional scan of the signal-emitting card 502.

In some embodiments, and as shown in FIG. 5, the signal tag system 102 can provide via the mobile device 506 an additional graphical user interface 504b where the signal tag system 102 can provide for display one or more selectable options to fulfill a subsequent request. As shown in FIG. 5, in one or more embodiments, the one or more selectable options can correspond to one or more payment methods (e.g., payment cards, payment accounts, etc.) associated with a signal-emitting card 502 within the user account. To illustrate, as shown in FIG. 5, the signal tag system 102 can receive a subsequent request to fulfill a transaction utilizing the signal-emitting card 502 by receiving a selection of selectable element 514 associated with the signal-emitting card 502. As further shown in FIG. 5, the signal tag system 102 can generate a threat prediction associated with the subsequent request by utilizing a card risk model 512 and wireless signal scanning flag 510. For example, based on the association of the wireless signal scanning flag 510 with the signal-emitting card 502, the signal tag system 102 can determine the threat prediction by analyzing features of the subsequent request, user account, and/or mobile device 506 with the card risk model 512. For example, the signal tag system 102 can receive a request to pay for a transportation service with the signal-emitting card 502. In one or more embodiments, while receiving the subsequent request, the signal tag system 102 can monitor activity associated with the signal-emitting card 502 and identify features related to the signal-emitting card 502, mobile device 506, and/or user account corresponding to the signal-emitting card 502. For example, the signal tag system 102 can identify the age of the user account, the age of the signal-emitting card 502 on the user account, addition date and time for the signal-emitting card 502, transaction history of the signal-emitting card 502, transaction history of the user account, transaction history of other payment methods, the location of the mobile device 506, transportation service history of the user account, the first and last name of the signal-emitting card 502 holder, etc.

In one or more embodiments, the signal tag system 102 can input the features and wireless signal scanning flag 510 into the card risk model 512. In one or more embodiments, based on the card risk model 512 analyzing the features associated with the signal-emitting card 502, the signal tag system 102 can generate a threat prediction. In certain implementations, the threat prediction can indicate a likelihood of fraud for the subsequent request utilizing the signal-emitting card 502. As further shown in FIG. 5, in one or more embodiments, the signal tag system 102 can generate a response to the subsequent request based on the threat prediction. As used herein, the term “response” refers to an answer and/or reaction to a subsequent response. For example, in one or more embodiments, a response can approve, deny, or ask for further verification of a signal-emitting card 402. In particular, the signal tag system 102 can generate a response by utilizing the threat prediction. For example, if the threat prediction does not indicate fraudulent activity related to a subsequent request, the signal tag system 102 can generate an approve transaction response 516 without requesting further verification.

As shown in FIG. 5, the signal tag system 102 can generate a response to the subsequent request. For example, in one or more embodiments, the subsequent request can be a request to complete a transaction with the signal-emitting card 502. In certain implementations, the signal tag system 102 can identify the wireless signal scanning flag 510 associated with the signal-emitting card 502 and input the wireless signal scanning flag 510 along with features associated with the transaction into the card risk model 512. In certain implementations, where the signal tag system 102 determines that the features associated with the transaction indicate a likelihood of fraud, the signal tag system 102 can generate a scan card response 518. In such embodiments, the signal tag system 102 can provide for display on the additional graphical user interface 504b a banner requesting an additional scan of the signal-emitting card 502 via the mobile device 506. In some cases, once the signal tag system 102 receives the additional scan of the signal-emitting card 502, the signal tag system 102 can complete the transaction. In certain cases, the signal tag system 102 can set a time limit for receiving the additional scan via the mobile device 506. For example, if the signal tag system 102 does not receive the additional scan via the mobile device 506 within one minute of requesting the additional scan, the signal tag system 102 can update the scan card response 518 to a deny transaction response 520 and freeze usage of the signal-emitting card 502.

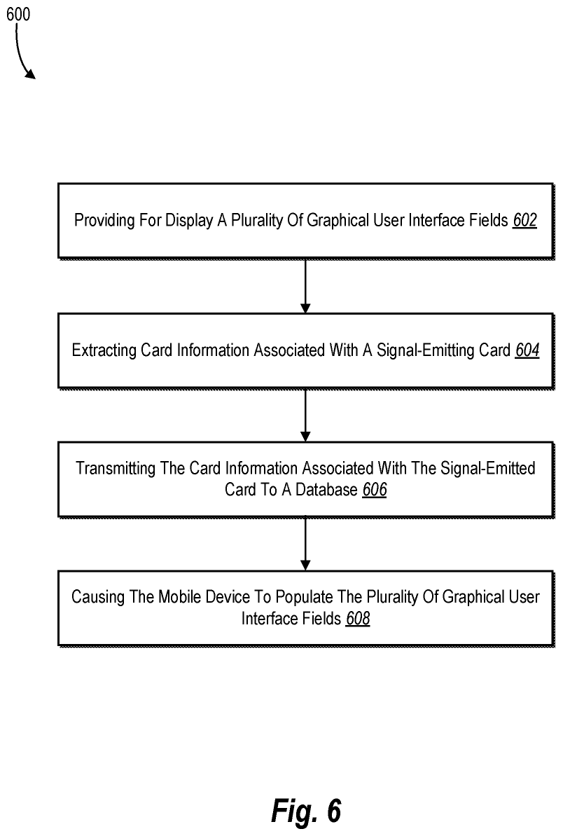

FIGS. 1-5, the corresponding text, and the examples provide a number of different systems, methods, and non-transitory computer-readable media for causing a mobile device to populate a plurality of graphical user interface fields by scanning a signal-emitting card and verifying use by an authorized user of the signal-emitting card within a transportation matching system 104. In addition to the foregoing, embodiments can also be described in terms of flowcharts comprising acts for accomplishing a particular result. For example, FIG. 6 illustrates a flowchart of an example sequence of acts in accordance with one or more embodiments.

For example, FIG. 6 illustrates a flowchart of an exemplary sequence of acts 600 for providing a first and second interfaces for synchronous display. In addition, FIG. 6 may be performed with more or fewer acts. Further, the acts may be performed in differing orders. Additionally, the acts described herein may be repeated or performed in parallel with one another or parallel with different instances of the same or similar acts.

While FIG. 6 illustrates the series of acts 600 according to particular embodiments, alternative embodiments may omit, add to, reorder, and/or modify any of the acts shown. The series of acts 600 can be performed as part of a method. Alternatively, a non-transitory computer-readable medium can comprise instructions, when executed by one or more processors, cause a computing device (e.g., a requestor mobile computing device and/or a server device) to perform the series of acts of 600. In still further embodiments, a system performs the series of acts of 600.

As shown, the series of acts 600 can include an act 602 of providing for display a plurality of graphical user interface fields. For example, the act 602 can involve providing, for display via a graphical user interface of a mobile device, a plurality of graphical user interface fields.

As shown, the series of acts 600 can include an act 604 of extracting card information associated with a signal-emitting card. For example, the act 604 can include extracting card information associated with a signal-emitting card via the mobile device, wherein the mobile device scans a wireless signal tag of the signal-emitting card to determine the card information associated with the signal-emitting card.

In one or more implementations the series of acts 600 can include an act 606 of transmitting the card information associated with the signal-emitted card to a database. In particular the act 606 can include transmitting the card information associated with the signal-emitting card to a database such that the card information is associated with a wireless signal scanning flag.

As further illustrated, the series of acts 600 can include an act 608 of causing the mobile device to populate the plurality of graphical user interface fields. For instance, the act 608 can involve causing the mobile device to populate the plurality of graphical user interface fields of the graphical user interface with the scanned card information associated with the signal-emitting card.

In various implementations, the series of acts 600 includes an additional act where the mobile device scans the wireless signal tag by scanning a near-field communication tag utilizing the mobile device. In some cases, the series of acts 600 includes an additional act where extracting the card information associated with the signal-emitting card comprises extracting an account number and an expiration date from the wireless signal tag.

In additional implementations, the series of acts 600 includes further acts of in response to causing the mobile device to populate the plurality of graphical user interface fields with the scanned card information from the signal-emitting card, causing the mobile device to freeze one or more of the plurality of graphical user interface fields. In one or more implementations, the series of acts 600 includes an act of in response to receiving a subsequent request to utilize the signal-emitting card, utilizing the wireless signal scanning flag to generate a response to the subsequent request.

In one or more embodiments, the series of acts 600 includes an additional act where utilizing the wireless signal scanning flag to generate the response to the subsequent request comprises generating, utilizing a card risk model, a threat prediction utilizing the wireless signal scanning flag, and generating the response to the subsequent request from the threat prediction. In some cases, the series of acts 600 also includes an additional act of receiving a subsequent request to utilize the signal-emitting card, based on the wireless signal scanning flag, requesting an additional scan of the signal-emitting card, and based on the additional scan, approving the subsequent request.

In some cases, the series of acts 600 includes an additional act of extracting the card information associated with the signal-emitting card without processing a transaction.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In one or more embodiments, computer-executable instructions are executed on a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. In this description, “cloud computing” is defined as a subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing subscription model can be composed of various characteristics such as, for example, on-demand self-service, broad network access, resource pooling, rapid elasticity, measured service, and so forth. A cloud-computing subscription model can also expose various service subscription models, such as, for example, Software as a Service (“SaaS”), a web service, Platform as a Service (“PaaS”), and Infrastructure as a Service (“IaaS”). A cloud-computing subscription model can also be deployed using different deployment subscription models such as private cloud, community cloud, public cloud, hybrid cloud, and so forth. In this description and in the claims, a “cloud-computing environment” is an environment in which cloud computing is employed.

FIG. 7 illustrates a block diagram of an example computing device 700 that may be configured to perform one or more of the processes described above. One will appreciate that one or more computing devices, such as the computing device 700 may represent the computing devices described above (e.g., the server(s) 106 or the mobile device 108). In one or more embodiments, the computing device 700 may be a mobile device (e.g., a mobile telephone, a smartphone, a PDA, a tablet, a laptop, a camera, a tracker, a watch, a wearable device, etc.). In some embodiments, the computing device 700 may be a non-mobile device (e.g., a desktop computer or another type of client device). Further, the computing device 700 may be a server device that includes cloud-based processing and storage capabilities.

As shown in FIG. 7, the computing device 700 can include one or more processor(s) 702, memory 704, a storage device 706, input/output interfaces 708 (or “I/O interfaces 708”), and a communication interface 710, which may be communicatively coupled by way of a communication infrastructure (e.g., bus 712). While the computing device 700 is shown in FIG. 7, the components illustrated in FIG. 7 are not intended to be limiting. Additional or alternative components may be used in other embodiments. Furthermore, in certain embodiments, the computing device 700 includes fewer components than those shown in FIG. 7. Components of the computing device 700 shown in FIG. 7 will now be described in additional detail.

In particular embodiments, the processor(s) 702 includes hardware for executing instructions, such as those making up a computer program. As an example, and not by way of limitation, to execute instructions, the processor(s) 702 may retrieve (or fetch) the instructions from an internal register, an internal cache, memory 704, or a storage device 706 and decode and execute them.

The computing device 700 includes the memory 704, which is coupled to the processor(s) 702. The memory 704 may be used for storing data, metadata, and programs for execution by the processor(s). The memory 704 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 704 may be internal or distributed memory.

The computing device 700 includes the storage device 706 for storing data or instructions. As an example, and not by way of limitation, the storage device 706 can include a non-transitory storage medium described above. The storage device 706 may include a hard disk drive (“HDD”), flash memory, a Universal Serial Bus (“USB”) drive or a combination these or other storage devices.

As shown, the computing device 700 includes one or more I/O interfaces 708, which are provided to allow a user to provide input to (such as user strokes), receive output from, and otherwise transfer data to and from the computing device 700. These I/O interfaces 708 may include a mouse, keypad or a keyboard, a touch screen, camera, optical scanner, network interface, modem, other known I/O devices or a combination of such I/O interfaces 708. The touch screen may be activated with a stylus or a finger.

The I/O interfaces 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 708 are configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 provides one or more interfaces for communication (such as, for example, packet-based communication) between the computing device and one or more other computing devices or one or more networks. As an example, and not by way of limitation, communication interface 710 may include a network interface controller (“NIC”) or network adapter for communicating with an Ethernet or other wire-based network or a wireless NIC (“WNIC”) or wireless adapter for communicating with a wireless network, such as a WI-FI. The computing device 700 can further include the bus 712. The bus 712 can include hardware, software, or both that connects components of computing device 700 to each other.

Each of the components of the signal tag system 102 can include software, hardware, or both. For example, the components can include one or more instructions stored on a computer-readable storage medium and executable by processors of one or more computing devices, such as a client device or server device. When executed by the one or more processors, the computer-executable instructions of the signal tag system 102 can cause the computing device(s) to perform the methods described herein. Alternatively, the components can include hardware, such as a special purpose processing device to perform a certain function or group of functions. Alternatively, the components of the signal tag system 102 can include a combination of computer-executable instructions and hardware.

Furthermore, the components of the signal tag system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

FIG. 8 illustrates an example network environment 800 of a signal tag system (e.g., the signal tag system 102). The network environment 800 includes a client device 806, a signal tag system 102, and a vehicle subsystem 808 connected to each other by a network 804. Although FIG. 8 illustrates a particular arrangement of the client device 806, the signal tag system 102, the vehicle subsystem 808, and the network 804, this disclosure contemplates any suitable arrangement of the client device 806, the signal tag system 102, the vehicle subsystem 808, and the network 804. As an example, and not by way of limitation, two or more of the client device 806, the signal tag system 102, and the vehicle subsystem 808 communicate directly, bypassing the network 804. As another example, two or more of the client device 806, the signal tag system 102, and the vehicle subsystem 808 may be physically or logically co-located with each other in whole or in part. Moreover, although FIG. 8 illustrates a particular number of the client devices 806, the signal tag system 102, the vehicle subsystems 808, and the networks 804, this disclosure contemplates any suitable number of the client devices 806, the signal tag system 102, the vehicle subsystems 808, and the networks 804. As an example, and not by way of limitation, the network environment 800 may include multiple client devices 806, signal tag system 102, multiple vehicle subsystems 808, and multiple networks 804.

This disclosure contemplates any suitable network 804. As an example, and not by way of limitation, one or more portions of the network 804 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network 804 may include one or more networks 804.

Links may connect the client device 806, the signal tag system 102, and the vehicle subsystem 808 to the network 804 or to each other. This disclosure contemplates any suitable links. In particular embodiments, one or more links include one or more wireline (such as, for example, Digital Subscriber Line (“DSL”) or Data Over Cable Service Interface Specification (“DOCSIS”)), wireless (such as, for example, Wi-Fi or Worldwide Interoperability for Microwave Access (“WiMAX”)), or optical (such as, for example, Synchronous Optical Network (“SONET”) or Synchronous Digital Hierarchy (“SDH”)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 800. One or more first links may differ in one or more respects from one or more second links.

In particular embodiments, the client device 806 may be an electronic device including hardware, software, or embedded logic components or a combination of two or more such components and capable of carrying out the appropriate functionalities implemented or supported by the client device 806. As an example, and not by way of limitation, a client device 806 may include any of the computing devices discussed above in relation to FIG. 8. A client device 806 may enable a network user at the client device 806 to access a network. A client device 806 may enable its user to communicate with other users at other client devices 806.

In particular embodiments, the client device 806 may include a transportation service application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 806 may enter a Uniform Resource Locator (“URL”) or other address directing the web browser to a particular server (such as the server(s) 106), and the web browser may generate a Hyper Text Transfer Protocol (“HTTP”) request and communicate the HTTP request to the server. The server may accept the HTTP request and communicate to the client device 806 one or more Hyper Text Markup Language (“HTML”) files responsive to the HTTP request. The client device 806 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the signal tag system 102 may be a network-addressable computing system that can host a ride share transportation network. The signal tag system 102 may generate, store, receive, and send data, such as, for example, user-profile data, concept-profile data, text data, ride request data, GPS location data, provider data, requestor data, vehicle data, or other suitable data related to the ride share transportation network. This may include authenticating the identity of providers and/or vehicles who are authorized to provide ride services through the signal tag system 102. In addition, the transportation service system may manage identities of service requestors such as users/requestors. In particular, the transportation service system may maintain requestor data such as driving/riding histories, personal data, or other user data in addition to navigation and/or traffic management services or other location services (e.g., GPS services).

In particular embodiments, the signal tag system 102 may manage ride matching services to connect a user/requestor with a vehicle and/or provider. By managing the ride matching services, the signal tag system 102 can manage the distribution and allocation of vehicle subsystem resources and user resources such as GPS location and availability indicators, as described herein.

The signal tag system 102 may be accessed by the other components of the network environment 800 either directly or via network 804. In particular embodiments, the signal tag system 102 may include one or more server(s). Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the signal tag system 102 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device 806 or the signal tag system 102 to manage, retrieve, modify, add, or delete, the information stored in data storage.

In particular embodiments, the signal tag system 102 may provide users with the ability to take actions on various types of items or objects, supported by the signal tag system 102. As an example, and not by way of limitation, the items and objects may include ride share networks to which users of the signal tag system 102 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the signal tag system 102 or by an external system of a third-party system, which is separate from the signal tag system 102 and coupled to the signal tag system 102 via the network 804.

In particular embodiments, the signal tag system 102 may be capable of linking a variety of entities. As an example, and not by way of limitation, the signal tag system 102 may enable users to interact with each other or other entities, or to allow users to interact with these entities through an application programming interfaces (“API”) or other communication channels.

In particular embodiments, the signal tag system 102 may include a variety of servers, sub-systems, programs, modules, logs, and data stores. In particular embodiments, the signal tag system 102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The signal tag system 102 may also include suitable components such as network interfaces, security mechanisms, load balancers, failover servers, management-and-network-operations consoles, other suitable components, or any suitable combination thereof. In particular embodiments, the signal tag system 102 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between the signal tag system 102 and one or more client devices 806. An action logger may be used to receive communications from a web server about a user's actions on or off the signal tag system 102. In conjunction with the action log, a third-party-content-object log may be maintained of user exposures to third-party-content objects. A notification controller may provide information regarding content objects to the client device 806. Information may be pushed to the client device 806 as notifications, or information may be pulled from the client device 806 responsive to a request received from the client device 806. Authorization servers may be used to enforce one or more privacy settings of the users of the signal tag system 102. A privacy setting of a user determines how particular information associated with a user can be shared. The authorization server may allow users to opt in to or opt out of having their actions logged by the signal tag system 102 or shared with other systems, such as, for example, by setting appropriate privacy settings. Third-party-content-object stores may be used to store content objects received from third parties. Location stores may be used for storing location information received from the client devices 806 associated with users.

In addition, the vehicle subsystem 808 can include a human-operated vehicle or an autonomous vehicle. A provider of a human-operated vehicle can perform maneuvers to pick up, transport, and drop off one or more requestors according to the embodiments described herein. In certain embodiments, the vehicle subsystem 808 can include an autonomous vehicle—e.g., a vehicle that does not require a human operator. In these embodiments, the vehicle subsystem 808 can perform maneuvers, communicate, and otherwise function without the aid of a human provider, in accordance with available technology.

In particular embodiments, the vehicle subsystem 808 may include one or more sensors incorporated therein or associated thereto. For example, sensor(s) can be mounted on the top of the vehicle subsystem 808 or else can be located within the interior of the vehicle subsystem 808. In certain embodiments, the sensor(s) can be located in multiple areas at once—i.e., split up throughout the vehicle subsystem 808 so that different components of the sensor(s) can be placed in different locations in accordance with optimal operation of the sensor(s). In these embodiments, the sensor(s) can include a LIDAR sensor and an inertial measurement unit (“IMU”) including one or more accelerometers, one or more gyroscopes, and one or more magnetometers. The sensor suite can additionally or alternatively include a wireless IMU (“WIMU”), one or more cameras, one or more microphones, or other sensors or data input devices capable of receiving and/or recording information relating to navigating a route to pick up, transport, and/or drop off a requestor.

In particular embodiments, the vehicle subsystem 808 may include a communication device capable of communicating with the client device 806 and/or the signal tag system 102. For example, the vehicle subsystem 808 can include an on-board computing device communicatively linked to the network 804 to transmit and receive data such as GPS location information, sensor-related information, requestor location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention. The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
providing, for display via a graphical user interface of a mobile device, a plurality of graphical user interface fields;
extracting card information associated with a signal-emitting card via the mobile device, wherein the mobile device scans a wireless signal tag of the signal-emitting card to determine the card information associated with the signal-emitting card;
transmitting the card information associated with the signal-emitting card to a database such that the card information is associated with a wireless signal scanning flag; and
causing the mobile device to populate the plurality of graphical user interface fields of the graphical user interface with the scanned card information associated with the signal-emitting card.

2. The computer-implemented method of claim 1, wherein the mobile device scans the wireless signal tag by scanning a near-field communication tag utilizing the mobile device.

3. The computer-implemented method of claim 1, wherein extracting the card information associated with the signal-emitting card comprises extracting an account number and an expiration date from the wireless signal tag.

4. The computer-implemented method of claim 1, further comprising in response to causing the mobile device to populate the plurality of graphical user interface fields with the scanned card information from the signal-emitting card, causing the mobile device to freeze one or more of the plurality of graphical user interface fields.

5. The computer-implemented method of claim 1, further comprising:
in response to receiving a subsequent request to utilize the signal-emitting card, utilizing the wireless signal scanning flag to generate a response to the subsequent request.

6. The computer-implemented method of claim 5, wherein utilizing the wireless signal scanning flag to generate the response to the subsequent request comprises:
generating, utilizing a card risk model, a threat prediction utilizing the wireless signal scanning flag; and
generating the response to the subsequent request from the threat prediction.

7. The computer-implemented method of claim 1, further comprising:
receiving a subsequent request to utilize the signal-emitting card;
based on the wireless signal scanning flag, requesting an additional scan of the signal-emitting card; and
based on the additional scan, approving the subsequent request.

8. The computer-implemented method of claim 1, further comprising:
extracting the card information associated with the signal-emitting card without processing a transaction.

9. A system comprising:
at least one processor; and
a non-transitory computer readable storage medium comprising instructions that, when executed by the at least one processor, cause the system to:
provide, for display via a graphical user interface of a mobile device, a plurality of graphical user interface fields;
extract card information associated with a signal-emitting card via the mobile device, wherein the mobile device scans a wireless signal tag of the signal-emitting card to determine the card information associated with the signal-emitting card;
transmit the card information associated with the signal-emitting card to a database such that the card information is associated with a wireless signal scanning flag; and
cause the mobile device to populate the plurality of graphical user interface fields of the graphical user interface with the scanned card information associated with the signal-emitting card.

10. The system of claim 9, wherein the mobile device scans the wireless signal tag by scanning a near-field communication tag utilizing the mobile device.

11. The system of claim 9, wherein extracting the card information associated with the signal-emitting card comprises extracting an account number and an expiration date from the wireless signal tag.

12. The system of claim 9, further comprising instructions that, when executed by the at least one processor, cause the system to:
in response to causing the mobile device to populate the plurality of graphical user interface fields with the scanned card information from the signal-emitting card, cause the mobile device to freeze one or more of the plurality of graphical user interface fields.

13. The system of claim 9, further comprising instructions that, when executed by the at least one processor, cause the system to:
in response to receiving a subsequent request to utilize the signal-emitting card, utilize the wireless signal scanning flag to generate a response to the subsequent request.

14. The system of claim 13, further comprising instructions that, when executed by the at least one processor, cause the system to:
generate, utilizing a card risk model, a threat prediction utilizing the wireless signal scanning flag; and
generate the response to the subsequent request from the threat prediction.

15. The system of claim 9, further comprising instructions that, when executed by the at least one processor, cause the system to:
receive a subsequent request to utilize the signal-emitting card;
based on the wireless signal scanning flag, request an additional scan of the signal-emitting card; and
based on the additional scan, approve the subsequent request.

16. A non-transitory computer readable storage medium comprising instructions that, when executed by at least one processor, cause the at least one processor to:
provide, for display via a graphical user interface of a mobile device, a plurality of graphical user interface fields;
extract card information associated with a signal-emitting card via the mobile device, wherein the mobile device scans a wireless signal tag of the signal-emitting card to determine the card information associated with the signal-emitting card;
transmit the card information associated with the signal-emitting card to a database such that the card information is associated with a wireless signal scanning flag; and
cause the mobile device to populate the plurality of graphical user interface fields of the graphical user interface with the scanned card information associated with the signal-emitting card.

17. The non-transitory computer readable storage medium of claim 16, wherein the mobile device scans the wireless signal tag by scanning a near-field communication tag utilizing the mobile device.

18. The non-transitory computer readable storage medium of claim 16, wherein extracting the card information associated with the signal-emitting card comprises extracting an account number and an expiration date from the wireless signal tag.

19. The non-transitory computer readable storage medium of claim 16, further comprising instructions that, when executed by the at least one processor, cause the at least one processor to:
in response to causing the mobile device to populate the plurality of graphical user interface fields with the scanned card information from the signal-emitting card, cause the mobile device to freeze one or more of the plurality of graphical user interface fields.

20. The non-transitory computer readable storage medium of claim 16, further comprising instructions that, when executed by the at least one processor, cause the at least one processor to:
in response to receiving a subsequent request to utilize the signal-emitting card, utilize the wireless signal scanning flag to generate a response to the subsequent request.
